(19) United States
(12) Patent Application Publication
(10) Pub. No.: US 2017/0203315 A1
(43) Pub. Date: Jul. 20, 2017

(54) METAL SURFACE RESTORATION SYSTEM

(71) Applicant: Ron Ivey, Marianna, FL (US)

(72) Inventor: Ron Ivey, Marianna, FL (US)

(21) Appl. No.: 15/001,744

(22) Filed: Jan. 20, 2016

(51) Int. Cl. B05B 9/08; B05B 12/00; B08B 3/02; B05B 9/01

(52) U.S. Cl. CPC B05B 9/0816; B05B 9/01; B05B 12/002; B08B 3/026

(57) ABSTRACT

A system for metal surface restoration that includes: a liquid solution, where the liquid solution includes a mixture of water, resin, polymer, liquid wax, plasticizer, mildew remover and a sealer; a container, where the container holds the liquid solution during use; and a hand spray attached to the container, where the hand spray enables the application of the liquid solution onto a metal surface. The system preferably includes a hose, where hose connects the hand spray to the container. The hand spray may also include a nozzle and a trigger, where a user depresses the trigger to emit the liquid solution out of the nozzle.

### BACKGROUND OF THE INVENTION

Field of Invention

The present invention relates to a system used to restore metal finish on shutters, roofing and metal shelters.

Description of Related Art

Many times individuals use metal storage containers and sheds to store tools and other accessories. Further metal siding, roofing and shutters are also used over the windows and a metal covering is used throughout residential and industrial buildings. One drawback to the use of this metal surface is that over time the metal surface becomes dull and faded due to weather conditions and exposure to the sun. These dull finishes diminish the aesthetic appearance of the building or facility and therefore individuals attempt to use various types of systems to restore the surface. Many times restoration requires painting the metal surface or using pressure washers or other types of cleaners to remove the residue and refurbish the surface. As a result, there is a need for a system that can restore dull and damaged metal surfaces typically associated with shutters, roofs and other metal shelters.

### SUMMARY OF THE INVENTION

The present invention relates to a system for metal surface restoration that includes: a liquid solution, where the liquid solution includes a mixture of water, resin, polymer, liquid wax, plasticizer, mildew remover and a sealer; a container, where the container holds the liquid solution during use; and a hand spray attached to the container, where the hand spray enables the application of the liquid solution onto a metal surface. The system preferably includes a hose, where hose connects the hand spray to the container. The hand spray may also include a nozzle and a trigger, where a user depresses the trigger to emit the liquid solution out of the nozzle.

### BRIEF DESCRIPTION OF DRAWINGS

FIG. 1 depicts a spray system used in accordance with their present invention.

### DETAILED DESCRIPTION

The present invention relates to a system to restore and refurbish dull and damaged metal surfaces through the use of a spray liquid application. This spray liquid application is applied through the use of a hand-held container with a hand sprayer that extends from the container. The liquid solution within the container provides a very effective restoration solution that is applied through the spraying system according to the present invention.

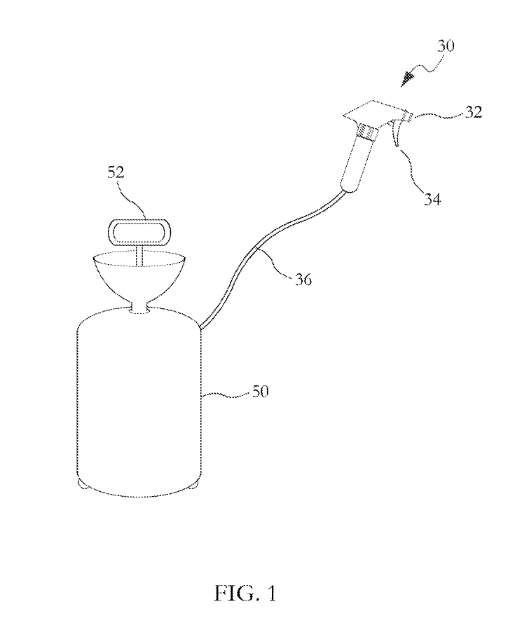

A liquid solution that includes a mixture of water, resin, polymer, liquid wax, plasticizer, mildew remover and sealer is placed within a container such as Container 50 shown in FIG. 1. The Container 50 has a handle 52 that is used to support and hold the Container 50 during application. Further the handle 52 may be used to apply additional pressure within the Container 50 to ensure that liquid is forced through a hose 36 that extends from the Container 50. At the distal end of the hose 36 is a hand spray 30. The hand spray 30 includes a nozzle 32 and trigger 34. During use, a user depresses the trigger 34 to emit the liquid solution out of the nozzle 32. This system allows an individual to carry the Container 50 while using the hand spray 30 to apply liquid over a metal surface. As stated, the liquid solution is comprised of a mixture of water, resin, polymer, liquid wax, plasticizer, mildew remover and a sealer to provide a unique solution for application over a metal surface.

The Container 50 includes a two-gallon liquid capacity so that the hand spray allows the individual to spray the solution over the shutters or other metal surfaces as necessary. Once the metal surface is covered with the surface is refurbished and provides an improved appearance and finish for the consumer. In one embodiment, the present invention may be incorporated on a backpack in order to spray large areas. The instant invention has been shown and described in what it considers to be the most practical and preferred embodiments. It is recognized, however, that departures may be made there from within the scope of the invention and that obvious modifications will occur to a person skilled in the art.

1. A system for metal surface restoration comprising:
a. a liquid solution, where the liquid solution includes a mixture of water, resin, polymer, liquid wax, plasticizer, mildew remover and a sealer;
b. a container, where the container holds the liquid solution during use; and
c. a hand spray attached to the container, where the hand spray enables the application of the liquid solution onto a metal surface.

2. The system for metal surface restoration according to claim 1, further including a hose, where hose connect the hand spray to the container.

3. The system for metal surface restoration according to claim 1, where the hand spray include a nozzle and a trigger, where a user depresses the trigger to emit the liquid solution out of the nozzle.
